(19) United States
(12) Patent Application Publication
(10) Pub. No.: US 2006/0075074 A1
(43) Pub. Date: Apr. 6, 2006

(54) Adaptor migration tool

(75) Inventors: Harold P. Perry, Seattle, WA (US); Krishna K. Vaishnav, Redmond, WA (US); Marc W. Whitman, Everett, WA (US)

Correspondence Address: WOODCOCK WASHBURN LLP, ONE LIBERTY PLACE, 46TH FLOOR, 1650 MARKET STREET, PHILADELPHIA, PA, 19103, US

(73) Assignee: Microsoft Corporation, Redmond, WA (US)

(21) Appl. No.: 10/935,335

(22) Filed: Sep. 7, 2004

(51) Int. Cl. G06F 15/177

(52) U.S. Cl. 709/220

(57) ABSTRACT

A system and method for interfacing disparate systems, comprising an adaptor migration tool for communicating with an end point manager of a first system and an application integration component of a second system, wherein the first system comprises a plurality of first properties, wherein the second system comprises a plurality of second properties, and wherein the adaptor migration tool performs a mapping function between the first properties and the second properties.

### FIELD OF THE INVENTION

The invention relates to software integration and in particular to interfaces enabling adaptor integration components to communicate with disparate systems.

### BACKGROUND OF THE INVENTION

An integration server or connector is a mechanism such as a computer server which is used to facilitate interaction between different operating systems and applications across internal and external networked computer systems. An integration server may facilitate interactions between different applications, exposing the functionality of one application to another application, to a client application, or to an application integration platform. For example, an integration server may facilitate interaction between different Line-of-Business applications by exposing the functionality of one Line-of-Business application to another Line-of-Business application. The Line-of-Business application may be an enterprise application that provides departmental or functional capabilities that may be used by a department or facility of an enterprise or by the entire enterprise. Prefabricated Line-of-Business applications such as SAP, Siebel, PeopleSoft, and Mumps, customized Line-of-Business applications and legacy Line-of-Business applications are common.

An enterprise integration server may also facilitate communication between databases, and may facilitate the use of different transport protocols. Example databases accessed may be Microsoft SQL Server, DB2 and Oracle. Exemplary transport protocols used may be HTTP, FTP, MQSeries and TCP-IP. For example, a corporation may have their client base or customer information in one software system and their human resources data in another. In order to retrieve and integrate data from both systems, the two systems must be connected. The integration server may provide the pipeline infrastructure to connect the two systems. Enterprise software may combine and process information from the different software.

An adaptor integration component is a software component that abstracts out specifics associated with a particular application, database, or protocol from the integration server. The adapter helps the Line-of-Business application to “adapt” to another Line-of-Business application by enabling it to use communications protocols and semantic interactions that the Line-of-Business application understands.

A problem may arise, however, when a new version of a software application is developed. If the software associated with, for example, one Line-of-Business application is modified or updated, an adaptor integration component may not be compatible with the new version and may require updating to ensure continued compatibility. For example, a corporation may have their client base or customer information in one software system and their human resources data in another. If the software system containing the customer information is updated or developed into a new version, the software system containing the human resources data may no longer be compatible and therefore, the systems may not be capable of being directly connected until the human resources software system or its adaptor integration component is updated accordingly. This updating may require revising or even rewriting the coding of the human resources software system or the adaptor integration component, creating a disincentive for implementing new versions of the customer information software system in the first place.

Therefore, there is a need to provide a mechanism for implementing a new version of an operating system or application software without requiring re-coding of adaptor integration components developed to communicate with an old version of the operating system or application software.

### SUMMARY OF THE INVENTION

An adaptor migration tool may be created to provide an interoperability layer between a system of one architecture and an adaptor integration component developed to communicate with a disparate system. A disparate system may be any type of system that requires an adaptor integration component to communicate with another application, such as, for example, a Line-of-Business application. The adaptor migration tool may preserve the ability of adaptor integration components to communicate with a disparate system in the event that, for example, the disparate system architecture is altered to take advantage of improvements in technology. If the adaptor integration component was developed to enable a disparate system to communicate with a component based processing system, for example, this same adaptor integration component may be operable with the system even if the system architecture is changed to a managed code base. The adaptor migration tool may provide this functionality by acting as an interface between the managed code based system and the adaptor integration component.

The adaptor migration tool may communicate with an end point manager of the managed code based system. The end point manager may facilitate communication between the managed code system and disparate systems and also may facilitate providing the adaptor migration tool with configuration, or default, properties consistent with the managed code based system. It should be recognized that disparate systems may include systems that communicate with the managed code based system without use of an intervening adaptor migration tool. The adaptor migration tool may communicate with an adaptor integration component of a disparate system that cannot communicate with the managed code based system without use of such an intervening tool. This may occur, for example, if the system has a managed code architecture and the adaptor migration tool (and its disparate system) has a component based processing architecture.

The adaptor migration tool may handle marshalling functions necessary to map the functionality of the adaptor integration component into the managed code based system. The adaptor migration tool may contain configuration, or default, properties. The adaptor migration tool may scan and select an adaptor integration component and view the source code for the component. The tool may then substitute coding for certain aspects of the source coding, primarily related to the properties of the adaptor integration component. In this way, the adaptor migration tool may “wrap” the adaptor integration component such that the managed code server can “see” and understand the adaptor integration component through the intervening adaptor migration tool.

### BRIEF DESCRIPTION OF THE DRAWINGS

The foregoing summary, as well as the following detailed description of illustrative embodiments, is better understood when read in conjunction with the appended drawings. For the purpose of illustrating the invention, there is shown in the drawings example constructions of the invention; however, the invention is not limited to the specific methods and instrumentalities disclosed. In the drawings:

FIG. 1 is a block diagram showing an example computing environment in which aspects of the adaptor migration tool may be implemented;

FIG. 2 is a block diagram of a system for ensuring communication between disparate systems through use of an adaptor migration tool;

FIG. 3 is a flow chart for a method of creating an adaptor migration tool for a given adaptor integration component; and

FIG. 4 is a flow chart for a method of using an adaptor migration tool.

### DETAILED DESCRIPTION OF ILLUSTRATIVE EMBODIMENTS

Overview

An adaptor migration tool may be developed and used as an interface between an adaptor integration component developed for a component based processing system and a disparate, managed code based system. For example, an adaptor integration component previously may have been developed to enable a component based processing system for a Line-of-Business application to communicate with a disparate system. If a new version of this Line-of-Business application is developed using managed code architecture, the adaptor integration component may no longer be able to facilitate direct communications between the Line-of-Business application and the disparate system.

An adaptor migration tool may be developed with configuration, or default, properties related to the managed code based, business integration system. The adaptor migration tool may become an interoperability layer over the adaptor integration component by performing a mapping function through substituting source coding of the adaptor integration component such that the managed code based system may communicate with the adaptor integration component. The adaptor migration tool, then, may handle marshalling functions necessary to map the functionality of the adaptor integration component to the managed code based system.

Example Computing Environment

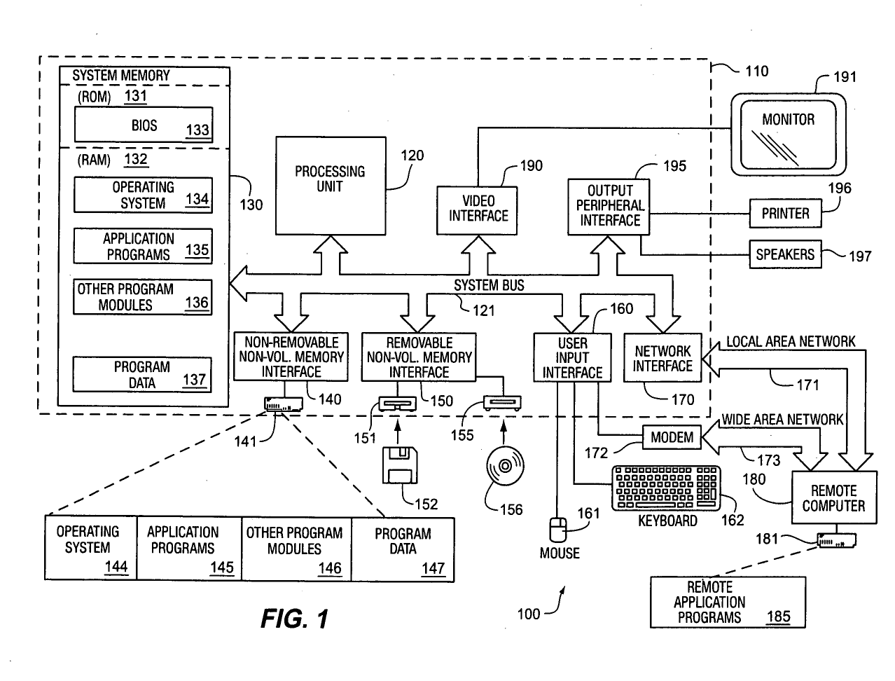

FIG. 1 and the following discussion are intended to provide a brief general description of a suitable computing environment in which an example embodiment of the invention may be implemented. It should be understood, however, that handheld, portable, and other computing devices of all kinds are contemplated for use in connection with the present invention. While a general purpose computer is described below, this is but one example. The present invention also may be operable on a thin client having network server interoperability and interaction. Thus, an example embodiment of the invention may be implemented in an environment of networked hosted services in which very little or minimal client resources are implicated, e.g., a networked environment in which the client device serves merely as a browser or interface to the World Wide Web.

Although not required, the invention can be implemented via an application programming interface (API), for use by a developer or tester, and/or included within the network browsing software which will be described in the general context of computer-executable instructions, such as program modules, being executed by one or more computers (e.g., client workstations, servers, or other devices). Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the invention may be practiced with other computer system configurations. Other well known computing systems, environments, and/or configurations that may be suitable for use with the invention include, but are not limited to, personal computers (PCs), automated teller machines, server computers, hand-held or laptop devices, multi-processor systems, microprocessor-based systems, programmable consumer electronics, network PCs, minicomputers, mainframe computers, and the like. An embodiment of the invention may also be practiced in distributed computing environments where tasks are performed by remote processing devices that are linked through a communications network or other data transmission medium. In a distributed computing environment, program modules may be located in both local and remote computer storage media including memory storage devices.

FIG. 1 thus illustrates an example of a suitable computing system environment 100 in which the invention may be implemented, although as made clear above, the computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

With reference to FIG. 1, an example system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, random access memory (RAM), read-only memory (ROM), Electrically-Erasable Programmable Read-Only Memory (EEPROM), flash memory or other memory technology, compact disc read-only memory (CDROM), digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media. Combinations of any of the above should also be included within the scope of computer readable media.

The system memory 130 includes computer storage media in the form of volatile and/or nonvolatile memory such as ROM 131 and RAM 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137. RAM 132 may contain other data and/or program modules.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the example operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1 provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120a-f through a user input interface 160 that is coupled to the system bus 121, but may be connected by other interface and bus structures, such as a parallel port, game port or a universal serial bus (USB).

A monitor 191 or other type of display device is also connected to the system bus 121 via an interface, such as a video interface 190. In addition to monitor 191, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

One of ordinary skill in the art can appreciate that a computer 110 or other client devices can be deployed as part of a computer network. In this regard, the present invention pertains to any computer system having any number of memory or storage units, and any number of applications and processes occurring across any number of storage units or volumes. An embodiment of the present invention may apply to an environment with server computers and client computers deployed in a network environment, having remote or local storage. The present invention may also apply to a standalone computing device, having programming language functionality, interpretation and execution capabilities.

System and Method for an Adaptor Migration Tool

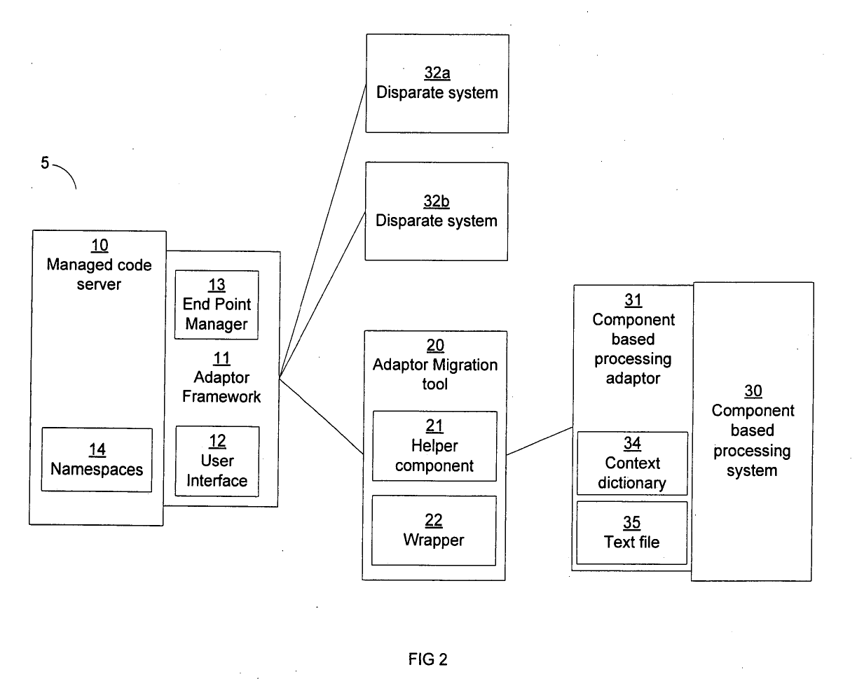

FIG. 2 is a block diagram of a system 5 in which an adaptor migration tool consistent with an example embodiment of the invention may be used. The adaptor migration tool may reside on one or more computers, each of which may be a computer 110 as described with regard to FIG. 1. The system 5 may include one or more of: a managed code server 10, an adaptor framework 11, an adaptor migration tool 20, a component based processing adaptor 31, and a component based processing system 30.

The managed code server 10 may be running a managed code based, server software application. The adaptor framework 11 may be a part of the managed code server 10 or may be in communication or otherwise associated with the managed code server 10. The adaptor framework 11 may enable the managed code server 10 to communicate with disparate systems 32a, 32b. The disparate components 32a, 32b may be managed code based systems or systems using other architecture.

The adaptor framework 11 may include a user interface 12 and an end point manager 13. The user interface 12 may receive information from tools within the server software. These tools may present the user interface 12 with information regarding the actions directed by disparate systems 32a, 32b. The end point manager 13 may contain generic coding for complying with the actions directed by the disparate systems 32a, 32b. For example, at run time, a document may be sent to the managed code server 10, which may determine the origination and destination of the document. The run time, end point manager may contain a generic method for looking through a list of adaptors, determining which adaptor should be used with the disparate systems 32a, 32b, loading the correct adaptor, and sending the document to the proper destination. In sum, the adaptor framework 11 may contain a generic framework, allowing the managed code server 10 to communicate with disparate systems such as the disparate systems 32a, 32b. The adaptor framework 11 therefore may present a common face potentially separated from the server software for adapters to make it easier for disparate systems 32a, 32b to communicate with the managed code server 10.

It should be recognized that managed code server 10 is just one example of the type of system for which an adaptor migration tool may be used 20. The adaptor migration tool 20 may be used with any type of system containing a device that performs substantially the same function as the end point manager 13.

The system 5 may also comprise a component based processing system 30. The component based processing system 30 may be component based processing and may be a computer as described with regard to FIG. 1. The component based processing system 30 may include or be in communication with a component based processing adaptor 31. The component based processing adaptor 31 may be an adapter integration component that enables the component based processing system 30 to communicate with other systems such as a component based processing version of a server software. A component based processing server software may be a version of the managed code server software that is running on managed code server 10. The component based processing adaptor 31 may not be readily able to communicate with the adaptor framework 11 or the managed code server 10 because, for example, the server software may be managed code based.

To overcome this incompatibility difficulty, in one embodiment of the invention, the component based processing adaptor 31 may be in communication with an adaptor migration tool 20. The adaptor migration tool 20 may be an interoperability layer and may enable the component based processing adaptor 31 (and therefore the component based processing system 30) to communicate and transfer data with the managed code server 10 through the adaptor framework 11 or otherwise through use of a device with functions substantially similar to end point manager 13.

In one example embodiment, the adaptor migration tool 20 may include a helper component 21 and may generate and compile a wrapper 22. The helper component 21 may be used to deploy generated adaptors from a development box to a production box. The adaptor migration tool generated artifacts may be placed on a single folder and this folder may be moved manually to the production (or any other box). The helper component 21 may be used to register the generated adaptors. The helper component 21 and the wrapper 22 may enable the component based processing adaptor 31 to communicate with the adaptor framework 11 of the managed code server 10.

The component based processing adaptor 31 may be configured to receive context properties from the component based processing server software through a context dictionary 34 contained in the server software or otherwise associated with component based processing system 30. Because the context dictionary may have no counterpart in the server software running on the managed code server 10, the component based processing adaptor 31 may be unable to communicate and transfer data with the adaptor framework 11 without the aid of the intervening helper component 21 and wrapper 22. This may be because the managed code based server software may contain properties in namespaces 14—not a context dictionary 34—which may have no correlation to the context dictionary 34 of the component based processing server software or component based processing system 30. Namespaces 14 may refer to specific areas of an extensible markup language (XML) file within the managed code based server software that represent one or more messages.

The adaptor migration tool 20, then, may generate a wrapper 22 that, with the aid of the helper component 21, may perform mapping between the available properties in the namespaces 14 of the managed code server 10 and the properties that the component based processing adaptor 31 may expect, namely a context dictionary 34. The mapping may be completed through use of an extensible style language (XSL) transform in XML. In this way, the adaptor migration tool 20 may be generate wrapper code that enables the managed code server 10 to “see” the component based processing adaptor.

Alternatively, the component based processing adaptor 31 may expect to receive text files 35 instead of a context dictionary 34. The adaptor migration tool 20 may work in a similar manner as described with regard to the context dictionary 34 and generate a wrapper that performs mapping between the namespaces 14 of the managed code server 10 and the text files 35 that the component based processing adaptor 31 may expect. This mapping also may be completed through use of an XSL transform in XML.

The user of the adaptor migration tool 20 may also be provided with the source code for the wrapper 22 that the adaptor migration tool 20 compiles so that the user may edit the source code. This may help ensure that the wrapper 22 provides compatibility between the managed code server 10 and the component based processing adaptor 31. In this way, after the wrapper 22 is generated, the presence of the adaptor migration tool 20 may not be necessary for the mapping function. For example, when moving to a production box, only the wrapper 22 and the helper component 21 need be moved.

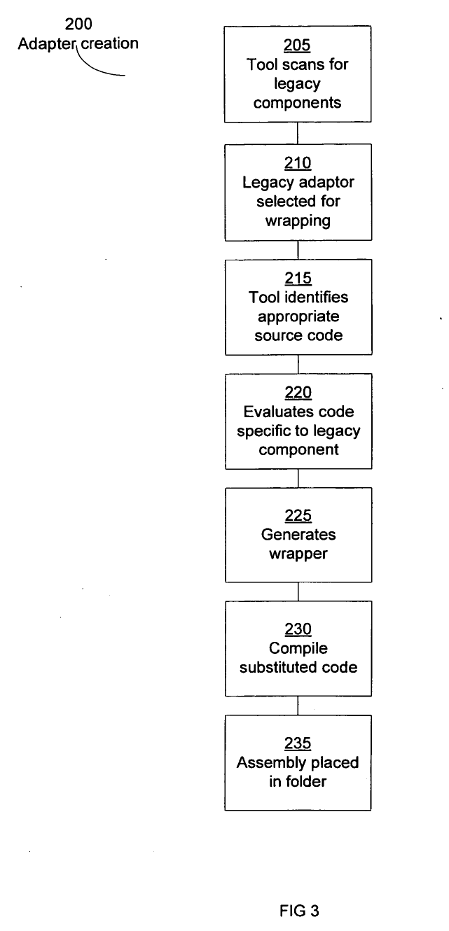

FIG. 3 depicts a flow diagram of one method 200 of creating an adaptor migration tool 20 in accordance with one embodiment of the invention. When the adaptor migration tool 20 receives a start event, such as a user opening or executing the adaptor migration tool 20, the adaptor migration tool 20 may, at step 205, scan the component based processing system 30 to determine if there are any legacy component based processing adaptors 31. If the adaptor migration tool 20 finds that there is more than one such component based processing adaptor 31, then at step 210 the adaptor migration tool 20 may either select a component based processing adaptor 31 or query a user (not shown) for the user to select the component based processing adaptor 31 desired for wrapping. If at step 210, the adaptor migration tool 20 finds one component based processing adaptor 31, then the adaptor migration tool 20 may automatically select the found component based processing adaptor 31.

Upon selection of the component based processing adaptor 31 for wrapping, the adaptor migration tool 20 may next, at step 215, identify the appropriate source code appropriate for the component based processing adaptor 31. For example, the component based processing adaptor 31 may be configured to receive context properties through a context dictionary. The adaptor migration tool 20 may therefore identify appropriate source code for generation of a wrapper 22. The source code may enable the wrapper 22 to wrap the component based processing adaptor 31 based on this configuration and map the context dictionary 34 to the namespaces 14 of the managed code server 10. The adaptor migration tool 20 may determine, also for example, that the component based processing adaptor 31 may be configured to receive properties through a text file 35. In this case, the adaptor migration tool 20 may identify source code for a wrapper 22 to map the text file 35 to the namespaces 14 of the managed code server 10. Based on this determination, at step 220, the adaptor migration tool 20 may generate code specific to the legacy component.

At step 225, the adaptor migration tool 20 may generate the wrapper 22. The wrapper 22 may handle marshalling functions necessary to map the component based processing functions to managed code functions. The substitutions may include program identifiers, globally unique identifiers (GUIDs) to make the adaptor component based processing adaptor unique with regard to other adaptors (not shown) that may be compatible with the adaptor framework 11 of the managed code server 10. The substitutions may also include object identifications used in the code to identify the component based processing adaptor 31 with which the adaptor framework 11 will interface, and filenames used for schema files. The schema files may be standard files required by the adaptor framework 11 in order to allow the user to configure the adaptor migration tool 20 and control its behavior.

The adaptor migration tool 20 may next, at step 230, compile the substituted source code. Finally, at step 235, the wrapper's compiled source code, its schema files, its support dynamic link libraries and other support files may be placed in a known folder to allow the adaptor or wrapper 21, in combination with the helper component 22, to be moved en masse from, for example, a developer's machine to a production machine.

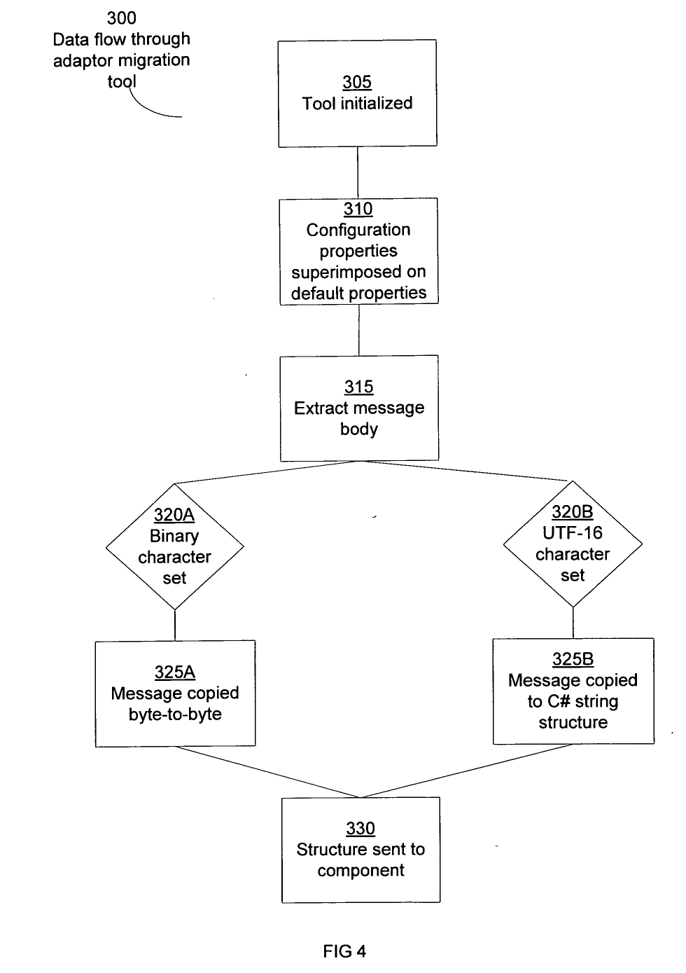

FIG. 4 depicts a flow diagram of data flow 300 through a runtime component based processing adaptor 31 with use of the adaptor migration tool 20 in accordance with an example embodiment of the invention. Regardless of whether the component based processing adaptor 31 is configured to receive properties through a context dictionary 34, a text file 35, or some other mechanism, the core infrastructure of the adaptor migration tool 20 may be substantially similar. The infrastructure of the adaptor migration tool 20 may be provided primarily by the managed code server 10 or the adaptor framework 11, which may implement the interfaces required of all adaptors by the adaptor framework 11 of the managed code server 10. As explained above with regard to FIG. 2, the managed code server 10 may be capable of communicating with disparate systems such as the disparate systems 32a, 32b without use of an adaptor migration tool 20. However, in the event that the disparate system's adaptor integration component is not able to communicate with the managed code server 10 through the adaptor framework 11 or otherwise, then the adaptor migration tool 20 or the wrapper 22 in combination with the helper 21 may be used. The infrastructure of the adaptor migration tool 20 (again, provided by or consistent with the managed code server 10) may handle all retry logic and message suspension logic, for example. In this way, the work of the adaptor migration tool 20 or the wrapper 22 may be focused on substituting code as explained with regard to FIG. 2 because the adaptor migration tool 20 may already contain, in the wrapper 22, the necessary, default infrastructure to facilitate the mapping function of this interoperability layer.

First, in step 305, the adaptor migration tool may be initialized and configuration properties may be called out in the managed code server software running on the managed code server 10. These configuration properties may be considered baseline default properties. The adaptor migration tool 20 may store these configuration properties in an internal structure called, for example, a configuration dictionary. In this way, once initialized, the adaptor migration tool 20 may be called at any time to handle a message. The message may go through the common infrastructure code and then may be processed by a method such as a ProcessMessage( ).

At step 310, the configuration properties may be gleaned from a namespace on the managed code server 10. Such a namespace may be an “AdaptorConfig” namespace of the message context, for example. The configuration properties gleaned may then be superimposed on the baseline default properties sent during the adaptor initialization, as explained above with regard to step 305.

Next, at step 315, the body of the message may be extracted. Depending on the configuration properties, the next step may vary. For example, if a property called “character set” is set to binary, then the body of the message may be copied, at step 325A, to a memory structure that contains a byte-to-byte representation of the original message. If, however, the “character set” property is set to Unicode Transformation Format (UTF) 16, for example, then the body of the message may be copied at step 325B to a structure such as a string structure in, for example, C# programming language. The string structure may be, for example, Unicode. At step 330, the message, whether copied byte-to-byte, copied to a string structure, or otherwise, may be sent to the component based processing adaptor 31, which may then be able to process the document.

In this way, the adaptor migration tool or the wrapper 22 in combination with the helper 21 may server as a interoperability layer, enabling the component based processing adaptor 31 of the component based processing system 30 to communicate with the managed code server 10. The interface provided by the adaptor migration tool 20 serves as a type of translator, altering context dictionary, text files, or other types of properties of a disparate system into the namespaces 14 properties understood by the managed code server 10. This mapping function is performed by the adaptor migration tool 20 or wrapper 21 by substituting source code of the component based processing adaptor 31 with code conforming to the namespaces 14. Of course, the mapping function may also be reversed, converting properties consistent with the namespaces 14 into context dictionary or text file properties recognized by the component based processing adaptor 31 and the component based processing system 30.

The various techniques described herein may be implemented in connection with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device will generally include a processor, a storage medium readable by the processor (including volatile and non-volatile memory and/or storage elements), at least one input device, and at least one output device. One or more programs that may utilize the creation and/or implementation of domain-specific programming models aspects of the present invention, e.g., through the use of a data processing API or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

While the present invention has been described in connection with the example embodiments of the various figures, it is to be understood that other embodiments may be used or modifications and additions may be made to the described embodiments for performing the same function of the present invention without deviating therefrom. Throughout the specification, a primary example was provided dealing with a managed code server and a component based processing adaptor integration component. The adaptor migration tool may be used, however, to provide for communication between systems and adaptor integration tools of other architectures as well. It should be recognized that the managed code server is just one example of the type of system for which an adaptor migration tool may be used. The adaptor migration tool may be used with any type of system containing a device that performs substantially the same function as the end point manager or that is required to map properties to and from data structures similar to namespaces. The examples provided throughout this specification do not limit the scope of the claimed invention and are provided to enhance understanding. Therefore, the present invention should not be limited to any single embodiment, but rather should be construed in breadth and scope in accordance with the appended claims.

What is claimed:

1. A system for interfacing disparate systems, comprising:
an adaptor migration tool for communicating with an end point manager of a first system and an application integration component of a second system,
wherein the first system comprises a plurality of first properties,
wherein the second system comprises a plurality of second properties, and
wherein the adaptor migration tool performs a mapping function between the first properties and the second properties.

2. The system of claim 1, wherein the first system is a managed code based system.

3. The system of claim 1, wherein the second system is a component processing based system.

4. The system of claim 1, wherein the properties of the second system are contained in a context dictionary.

5. The system of claim 1, wherein the properties of the second system are contained in a text file.

6. The system of claim 1, wherein the properties of the first system are contained in namespaces.

7. The system of claim 1, wherein the adaptor migration tool maps properties between the first and second systems using XML.

8. The system of claim 1, wherein the first system further comprises a user interface.

9. The system of claim 1, wherein an adaptor framework of the first system comprises the user interface and the end point manager.

10. The system of claim 1, wherein the adaptor migration tool comprises infrastructure that enables the adaptor migration tool to process retry and message suspension logic.

11. The system of claim 1, wherein the adaptor migration tool generates a wrapper and wherein the wrapper performs the mapping function.

12. A system for interfacing disparate systems, comprising:
an adaptor migration tool for communicating with a first system comprising a plurality of namespaces and an application integration component of a second system,
wherein the plurality of namespaces comprise respective first properties of the first system;
wherein the second system comprises a plurality of second properties, and
wherein the adaptor migration tool performs a mapping function between the first properties and the second properties.

13. The system of claim 12, wherein the first system is a managed code based system.

14. The system of claim 12, wherein the second system is a component processing based system.

15. The system of claim 12, wherein the properties of the second system are contained in a context dictionary.

16. The system of claim 12, wherein the properties of the second system are contained in a text file.

17. The system of claim 12, wherein the adaptor migration tool maps properties between the first and second systems using XML.

18. The system of claim 12, wherein the first system comprises an end point manager.

19. The system of claim 12, wherein the first system comprises a user interface.

20. The system of claim 12, wherein the adaptor migration tool comprises infrastructure that enables the adaptor migration tool to process retry and message suspension logic.

21. A method for facilitating communications between a first system and an adaptor integration component of a second system, wherein the first system comprises first properties, namespaces, and an end point manager and the adaptor integration component comprises second properties, the method comprising:
configuring an adaptor migration tool with the first properties such that the adaptor migration tool may communicate with at least one of the end point manager and namespaces;
identifying source code of the second properties; and
substituting code for source code of the second properties such that the adaptor migration tool maps between first and second properties.

22. The method of claim 21, further comprising:
scanning the second system for adaptor integration components; and
selecting an adaptor integration component of the second system.

23. The method of claim 21, wherein the first properties are located in namespaces.

24. The method of claim 21, wherein the first system is a managed code based system.

25. The method of claim 21, wherein the adaptor integration component is a component based processing adaptor.

26. A computer-readable medium having computer-executable instructions for facilitating communication between a first system and an adaptor integration component of a second system, wherein the first system comprises first properties, namespaces, and an end point manager and the adaptor integration component comprises second properties, the computer-executable instructions comprising:
configuring an adaptor migration tool with the first properties such that the adaptor migration tool may communicate with at least one of an end point manager and namespaces;
identifying source code of the first properties;
substituting code for source code of the first properties such that the adaptor migration tool maps between first and second properties.

27. The computer-readable medium of claim 26, having further computer-executable instructions for performing the step of:
scanning the second system for adaptor integration components; and
selecting an adaptor integration component of the second system.
